(19) United States
(12) Patent Application Publication
(10) Pub. No.: US 2013/0169596 A1
(43) Pub. Date: Jul. 4, 2013

(54) THREE-DIMENSIONAL INTERACTION DISPLAY AND OPERATION METHOD THEREOF

(71) Applicant: AU OPTRONICS CORP., Hsin-Chu (TW)

(72) Inventors: Guo-Zhen Wang, Hsin-Chu (TW); Shu-Yi Huang, Hsin-Chu (TW); Yi-Pai Huang, Hsin-Chu (TW); An-Thung Cho, Hsin-Chu (TW); Jiun-Jye Chang, Hsin-Chu (TW)

(73) Assignee: AU OPTRONICS CORP., Hsin-Chu (TW)

(21) Appl. No.: 13/711,796

(22) Filed: Dec. 12, 2012

(30) Foreign Application Priority Data
Dec. 30, 2011 (TW) 100150026

(51) Int. Cl. G06F 3/042

(52) U.S. Cl. CPC G06F 3/0425
USPC 345/175

(57) ABSTRACT

A three-dimensional interaction display includes a display panel having a plurality of light sensing devices, a first light emitting device, a second light emitting device, and a processing circuit. The first light emitting device includes a first light emitting surface including a first pattern, and the first pattern includes a first shape boundary having a first total length. The second light emitting device includes a second light emitting surface including a second pattern, and the second pattern includes a second shape boundary having a second total length. The processing circuit is electrically connected to the plurality of light sensing devices for processing an image obtained by the light sensing devices, calculating the total length of the shape boundary of each of the patterns shown in the obtained image, and determining the corresponding light emitting device according to the total length of the shape boundary of each of the patterns.

### BACKGROUND

1. Field of the Invention

The present invention relates to touch control technologies, and more particularly to a three-dimensional interaction display and an operation method thereof.

2. Description of the Related Art

Generally, when operating a three-dimensional interaction display having a light sensing device, users need only make light emitted from a light emitting device, such as a light pen, project on a display panel of the three-dimensional interaction display, and thus an image will be obtained by the light sensing device. And then, location information of the light emitting device can be determined according to a light spot in the obtained image. The described location information for example, is a two-dimensional relative location between the light emitting device and the display surface of the display panel, or a relative distance between the light emitting device and the display surface.

However, when at least two identical light emitting devices are applied in the three-dimensional interaction display, the three-dimensional interaction display is hard to distinguish the light emitting devices, so as to the three-dimensional interaction display can't interact with the light emitting devices. In other words, the existing three-dimensional interaction display is unable to support multi-point interaction operation.

### BRIEF SUMMARY

The present invention relates to a three-dimensional interaction display can support multi-point interaction operation.

The present invention also relates to an operation method of the three-dimensional interaction display.

To achieve the above advantages, a three-dimensional interaction display in accordance with an exemplary embodiment of the present invention is provided. The three-dimensional interaction display comprises a display panel comprising a plurality of light sensing devices, a first light emitting device, a second light emitting device, and a processing circuit. The first light emitting device comprises a first light emitting surface, the first light emitting surface comprises a first pattern, the first pattern comprises a first shape boundary and the first shape boundary has a first total length. The second light emitting device comprises a second light emitting surface, the second light emitting surface comprises a second pattern, the second pattern comprises a second shape boundary and the second shape boundary has a second total length. The processing circuit is electrically connected to the plurality of light sensing devices and is configured for processing an image obtained by the light sensing devices, calculating the total length of the shape boundary of each of the patterns shown in the obtained image, and determining the corresponding light emitting device according to the total length of the shape boundary of each of the patterns shown in the obtained image.

In an embodiment of the present invention, the processing circuit is operable to label pixels in the obtained image having sharp changes in brightness using an edge detection algorithm, and calculate total numbers of the labeled pixels belonging to each pattern which is regarded as the total length of the shape boundary of the corresponding patterns.

In an embodiment of the present invention, the processing circuit is operable to calculate position information of each of the patterns shown in the obtained image, the position information of each of the patterns comprises at least one of a location data and a distance data, the location data indicates relative location of the fist light emitting device or the light emitting device on the display surface, the distance data indicates a distance between the first light emitting device and the display surface or a distance between the second light emitting device and the display surface.

In an embodiment of the present invention, the processing circuit is operable to determine a first angle between the light path of the light rays emitted from the first light emitting device and the display surface, a second angle between the light path of the light rays emitted from the second light emitting device and the display surface, a first rotation angle of the first light emitting device about a first axis thereof, or a second rotation angle of the second light emitting device about a second axis thereof, the first axis is perpendicular to the first light emitting surface and through the center thereof, and the second axis is perpendicular to the second light emitting surface and through the center thereof.

In an embodiment of the present invention, light emitted from the first light emitting device and the second light emitting device is infrared light, the display panel is configured with a plurality of infrared filters, the infrared light filters only permits infrared light passing through, and each of the light sensing device is coupled to one of the infrared light filters to obtain the image.

To achieve the above advantages, an operation method of the three-dimensional interaction display mentioned above in accordance with another exemplary embodiment of the present invention is provided. The operation method comprises steps of: obtaining an image by the light sensing devices; calculating the total length of the shape boundary of each of the patterns shown in the obtained image; and determining the corresponding light emitting device according to the total length of the shape boundary of each of the patterns shown in the obtained image.

In an embodiment of the present invention, the step of calculating the total length of the shape boundary of each of the patterns shown in the obtained image comprises steps of: labeling pixels in the image having sharp changes in brightness using an edge detection algorithm; calculating total numbers of the labeled pixels belonging to each pattern; and regarding the total numbers of the labeled pixels belonging to each pattern as the total length of the shape boundary of the corresponding patterns.

In an embodiment of the present invention, the operation method further comprises step of calculating position information of each of the patterns shown in the obtained image, wherein the position information of each of the patterns comprises at least one of a location data and a distance data, the location data indicates relative location of the fist light emitting device or the light emitting device on the display surface, the distance data indicates a distance between the first light emitting device and the display surface or a distance between the second light emitting device and the display surface.

In an embodiment of the present invention, the operation method further comprises step of determining a first angle between the light path of the light rays emitted from the first light emitting device and the display surface, a second angle between the light path of the light rays emitted from the second light emitting device and the display surface, a first rotation angle of the first light emitting device about a first axis thereof, or a second rotation angle of the second light emitting device about a second axis thereof, wherein the first axis is perpendicular to the first light emitting surface and through the center thereof, and the second axis is perpendicular to the second light emitting surface and through the center thereof.

In an embodiment of the present invention, light emitted from the first light emitting device and the second light emitting device is infrared light, the display panel is configured with a plurality of infrared filters, the infrared light filters only permits infrared light passing through, and each of the light sensing device is coupled to one of the infrared light filters to obtain the image.

The three-dimensional interaction display in the present invention includes a plurality of light emitting devices, each of the light emitting devices has a light emitting surface and each of the light emitting surfaces has one pattern formed thereon. The patterns on each of the light emitting surfaces have different shape boundary, so the patterns on each of the light emitting surfaces have different total length of the shape boundary. The processing circuit is operable to process the image obtained by the light sensing devices, therefore once the light emitting device projects the pattern on the display panel of the three-dimensional interaction display, the processing circuit can calculate the total length of the shape boundary of each of the patterns shown in the obtained image, and determine the corresponding light emitting device according to the total length of the shape boundary of each of the patterns shown in the image. In other words, the three-dimensional interaction display in the present invention can distinguish different light emitting devices, and thus the three-dimensional interaction display 100 can support multi-point interaction operations.

### BRIEF DESCRIPTION OF THE DRAWINGS

FIG. 1 is a schematic view of a three-dimensional interaction display in accordance with a preferred embodiment of the present invention.

FIG. 2 is a sectional view of another display panel.

FIG. 3 shows more examples of “T” shaped patterns having different total length of the shape boundary thereof.

FIG. 4 is a flow chart of an operation method of the three-dimensional display.

### DETAILED DESCRIPTION

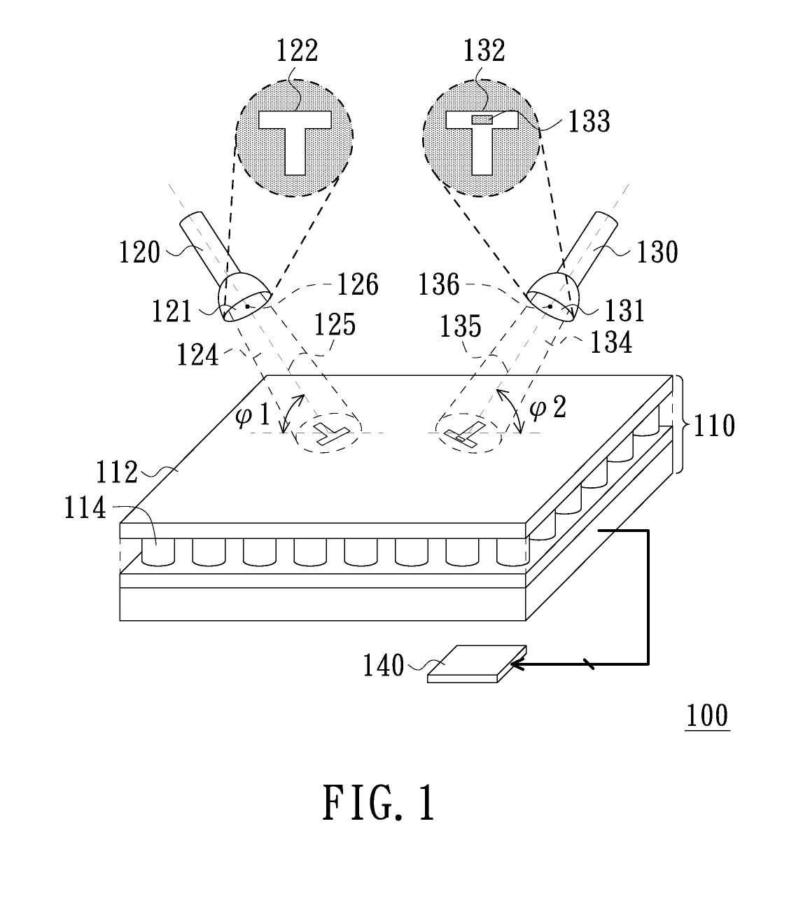

FIG. 1 is a schematic view of a three-dimensional interaction display in accordance with a preferred embodiment of the present invention. Referring to FIG. 1, the three-dimensional interaction display 100 includes a display panel 110, a first light emitting device 120, a second light emitting device 130, and a processing circuit 140. The display panel 110 includes a display surface 112 and a plurality of light sensing devices 114. In the exemplary embodiment, the light sensing devices 114 are arranged in a matrix and disposed in the display panel 110 uniformly. The first light emitting device 120 includes a first light emitting surface 121. The first light emitting surface 121 includes a first pattern 122 formed thereon. In the exemplary embodiment, the first pattern 122 is a capital letter “T”. The first pattern 122 has a first shape boundary and the first shape boundary has a first total length, i.e. the total length of the boundary of the capital letter “T”. The first pattern 122 can be formed by providing a black coating over an area of the first light emitting surface 121 outside the first shape boundary of the first pattern 122. Light only can pass through the area of the first light emitting surface 121 inside the first shape boundary of the first pattern 122, and thus the first pattern has the first shape boundary, i.e., the outer boundary of the capital letter “T”. Light rays 124 emitted from the first light emitting device 120 pass through the first light emitting surface 121, therefore, the first pattern 122 can be projected onto a surface which is illuminated by the first light emitting device 120.

The second light emitting device 130 includes a second light emitting surface 131. The second light emitting surface 131 includes a second pattern 132 formed thereon. In the exemplary embodiment, the second pattern 132 is shaped like a capital letter “T”. More specifically, in the exemplary embodiment, the second pattern 132 has a same outer boundary shape with the first pattern 122, but unlike the first pattern 122, the second pattern has a dark area 133 formed inside the capital letter “T”. The second pattern 132 has a second shape boundary and the second shape boundary has a second total length, i.e. the total length of the outer boundary of the capital letter “T” plus the total length of the boundary of the dark area 133. The second pattern 132 can be formed by providing a black coating over an area of the second light emitting surface 131 outside the outer boundary of the capital letter “T” and inside the boundary of the dark area 133. Accordingly, light only can pass through the area of the second light emitting surface 131 inside the second shape boundary of the second pattern 132, i.e. the area between the outer boundary of the capital letter “T” and the boundary of the dark area 133. Light rays 134 emitted from the second light emitting device 130 pass through the second light emitting surface 131, therefore, the second pattern 132 is projected onto a surface which is illuminated by the second light emitting device 130.

The processing circuit 140 is electronically connected with each of the light sensing devices 114 to receive and process an image obtained by the light sensing devices 114, and calculates the total length of shape boundary of each of the patterns shown in the obtained image. For example, pixels in the obtained image having sharp changes in brightness can be labeled by the processing circuit 140 using an edge detection algorithm. Gradient transport operator can be used in the edge detection algorithm. More specifically, the gradient transport operator includes, but not limited to, Sobel gradient transport operator, Prewitt gradient transport operator, Robert gradient transport operator, Laplacian gradient transport operator, or LoG gradient transport operator. It can be understood that other edge detection operator, such as Canny edge detector can also be used in the edge detection algorithm in the present invention. After the pixels in the obtained image having sharp changes in brightness have been labeled, the processing circuit 140 calculates total numbers of the labeled pixels belonging to each pattern in the obtained image. The total number of labeled pixels belonging to each pattern is regarded as the total length of the shape boundary of the corresponding patterns, so as to the corresponding light emitting device can be determined by the processing circuit 140 according to the total length of the shape boundary of each of the patterns shown in the obtained image.

The processing circuit 140 is also operable to calculate the position information of the first light emitting device 120 and the second light emitting device 130 corresponding to the patterns shown in the obtained image. The position information includes at least one of a location data and a distance data. The location data indicates relative location of the first light emitting device 120 or the second light emitting device 130 on the display surface 112 of the display panel 110. The distance data indicates a distance between the first light emitting device 120 and the display surface 112 of the display panel 110, or a distance between the second light emitting device 130 and the display surface 112 of the display panel 110. The distance between the first light emitting device 120 and the display surface 112 or the distance between the second light emitting device 130 and the display surface 112 can be calculated according to the size of corresponding patterns in the obtained image. In addition, according to the obtained image, the processing circuit 140 is also operable to determine a first angle between the light path of the light rays emitted from the first light emitting device 120 and the display surface 112, a second angle between the light path of the light rays emitted from the second light emitting device 130 and the display surface 112, a first rotation angle of the first light emitting device 120 about a first axis 125 thereof, or a second rotation angle of the second light emitting device 130 about a second axis 135 thereof. The first or the second rotation angle describes the magnitude of the rotation of the first or the second light emitting device about the first axis or the second axis. The first axis 125 is perpendicular to the first light emitting surface 121 and through the center 126 thereof. The second axis 135 is perpendicular to the second light emitting surface 131 and through the center 136 thereof. In FIG. 1, the first angle between the light path of the light rays emitted from the first light emitting device 120 and the display surface 112 is labeled as φ1, and the second angle between the light path of the light rays emitted from the second light emitting device 130 and the display surface 112 is labeled as φ2. In FIG. 1, if the first light emitting device 120 rotates about the axis 125, the first pattern projected on the display surface 112 also rotates with the first light emitting device 120, and if the second light emitting device 130 rotates about the axis 135, the second pattern projected on the display surface 112 also rotates with the second light emitting device 130.

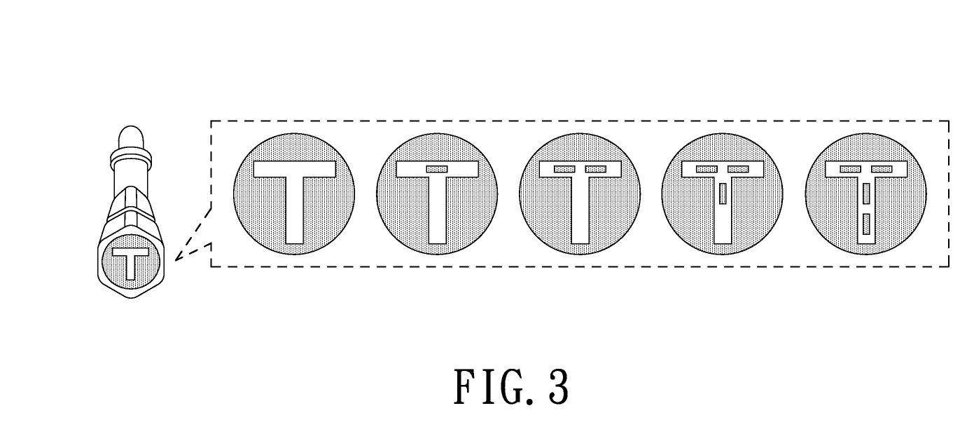

The value of φ1 and φ2, i.e. the first angle between the light path of the light rays emitted from the first light emitting device 120 and the display surface 112 and the second angle between the light path of the light rays emitted from the second light emitting device 130 and the display surface 112, can be determined by the processing circuit 140, such as according to the aspect ratio of the corresponding patterns in the obtained image. Since the first pattern and the second pattern can be designed to be asymmetry, the processing circuit 140 is operable to determine the first rotation angle of the first light emitting device 120 about the first axis 125 thereof or the second rotation angle of the second light emitting device 130 about the second axis 135 thereof according to the rotation angle of the corresponding patterns in the obtained image. Though these designs, the three-dimensional interaction display 100 can distinguish different light emitting devices, so as to the three-dimensional interaction display 100 can support multi-point interaction operations. Although only two light emitting devices to be illustrated in above embodiment, the present invention is not as limited. FIG. 3 shows more examples of “T” shaped patterns having different total length of the shape boundary thereof. As shown in FIG. 3, these “T” shaped patterns have different numbers of black areas formed inside the capital letter “T”, so these “T” shaped patterns have different total length of the shape boundary.

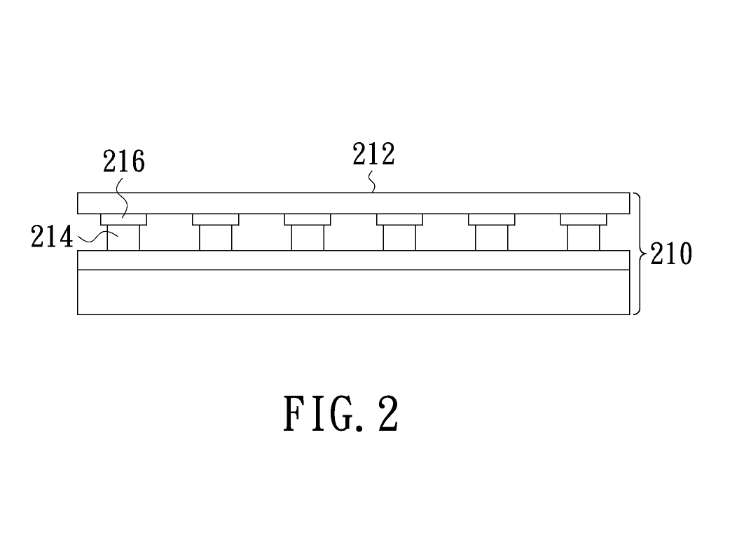

It is worth mentioning that, light emitted from the first light emitting device 120 and the second light emitting device 130 can be infrared light, to avoid interfering with the picture shown on the display panel. Of course, correspondingly, the display panel should be configured with a plurality of infrared filters. FIG. 2 is a sectional view of a display panel in accordance with another exemplary embodiment of the present invention, referring to FIG. 2, the display panel 210 includes a display surface 212, a plurality of light sensing device 214, and a plurality of infrared light filters 216. The infrared light filters 216 only permits infrared light passing through, and each of the light sensing device 214 is coupled to one of the infrared light filters 216 to obtain the image. Of course, if the light sensing devices 214 can sense the infrared light by itself, the infrared light filters 216 can be omitted in the display panel 210.

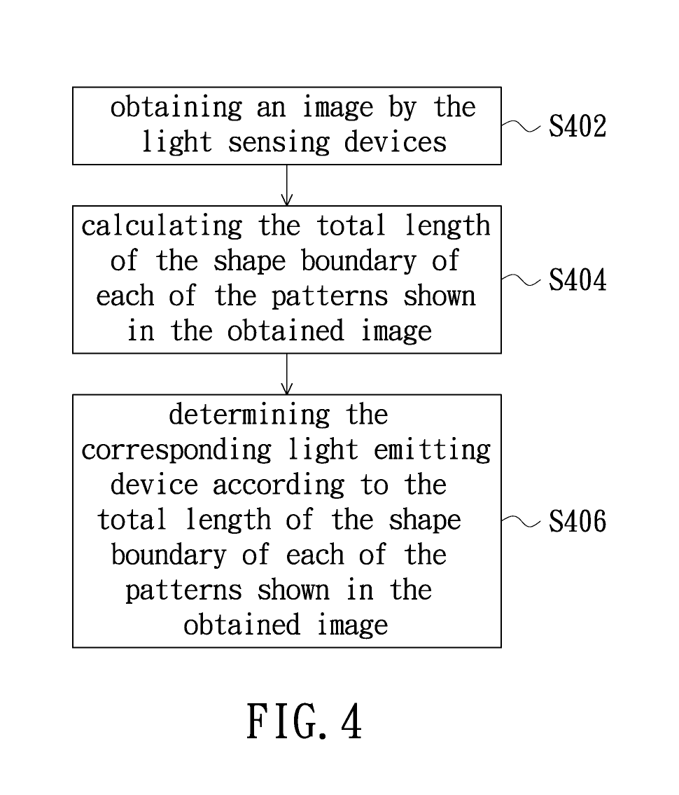

Shown by the above teaching, an operation method of the three-dimensional interaction display can be concluded by people skilled in the art. FIG. 4 is a flow chart of an operation method of the three-dimensional display. Referring to FIG. 4, the three-dimensional interaction display includes a display panel, a first light emitting device and a second light emitting device. The display panel includes a plurality of light sensing device. The first light emitting device includes a first light emitting surface, and the first light emitting surface includes a first pattern formed thereon. The first pattern has a first shape boundary and the first shape boundary has a first total length. The second light emitting device includes a second light emitting surface, and the second light emitting surface includes a second pattern formed thereon. The second pattern has a second shape boundary and the second shape boundary has a second total length. The operation method of the three-dimensional interaction display includes the steps of: obtaining an image by the light sensing devices (S402); calculating the total length of the shape boundary of each of the patterns shown in the obtained image (S404); and determining the corresponding light emitting device according to the total length of the shape boundary of each of the patterns shown in the obtained image (S406).

In summary, the three-dimensional interaction display of the embodiments in the present invention includes a plurality of light emitting devices, each of the light emitting devices has a light emitting surface and each of the light emitting surfaces has one pattern formed thereon. The patterns on each of the light emitting surfaces have different shape boundary, so the patterns on each of the light emitting surfaces have different total length of the shape boundary. The processing circuit is operable to process the image obtained by the light sensing devices, therefore once the light emitting device projects the pattern on the display panel of the three-dimensional interaction display, the processing circuit can calculate the total length of the shape boundary of each of the patterns shown in the obtained image, and determine the corresponding light emitting device according to the total length of the shape boundary of each of the patterns shown in the image. In other words, the three-dimensional interaction display in the present invention can distinguish different light emitting devices, and thus the three-dimensional interaction display 100 can support multi-point interaction operations.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A three-dimensional interaction display, comprising:
a display panel comprising a plurality of light sensing devices;
a first light emitting device comprising a first light emitting surface, the first light emitting surface comprising a first pattern, the first pattern comprising a first shape boundary and the first shape boundary having a first total length;
a second light emitting device comprising a second light emitting surface, the second light emitting surface comprising a second pattern, the second pattern comprising a second shape boundary and the second shape boundary having a second total length; and
a processing circuit electrically connected to the plurality of light sensing devices and configured for processing an image obtained by the light sensing devices, calculating the total length of the shape boundary of each of the patterns shown in the obtained image, and determining the corresponding light emitting device according to the total length of the shape boundary of each of the patterns shown in the obtained image.

2. The three-dimensional interaction display as claimed in claim 1, wherein the processing circuit is operable to label pixels in the obtained image having sharp changes in brightness using an edge detection algorithm, and calculate total numbers of the labeled pixels belonging to each pattern which is regarded as the total length of the shape boundary of the corresponding patterns.

3. The three-dimensional interaction display as claimed in claim 1, wherein the processing circuit is operable to calculate position information of each of the patterns shown in the obtained image, the position information of each of the patterns comprises at least one of a location data and a distance data, the location data indicates relative location of the fist light emitting device or the light emitting device on the display surface, the distance data indicates a distance between the first light emitting device and the display surface or a distance between the second light emitting device and the display surface.

4. The three-dimensional interaction display as claimed in claim 1, wherein the processing circuit is operable to determine a first angle between the light path of the light rays emitted from the first light emitting device and the display surface, a second angle between the light path of the light rays emitted from the second light emitting device and the display surface, a first rotation angle of the first light emitting device about a first axis thereof, or a second rotation angle of the second light emitting device about a second axis thereof, the first axis is perpendicular to the first light emitting surface and through the center thereof, and the second axis is perpendicular to the second light emitting surface and through the center thereof.

5. The three-dimensional interaction display as claimed in claim 1, wherein light emitted from the first light emitting device and the second light emitting device is infrared light, the display panel is configured with a plurality of infrared filters, the infrared light filters only permits infrared light passing through, and each of the light sensing device is coupled to one of the infrared light filters to obtain the image.

6. An operation method of a three-dimensional interaction display, the three-dimensional interaction display comprising a display panel comprising a plurality of light sensing devices, a first light emitting device, a second light emitting device, and a processing circuit, the first light emitting device comprising a first light emitting surface, the first light emitting surface comprising a first pattern, the first pattern comprising a first shape boundary and the first shape boundary having a first total length, the second light emitting device comprising a second light emitting surface, the second light emitting surface comprising a second pattern, the second pattern comprising a second shape boundary and the second shape boundary having a second total length, the operation method comprising steps of:
obtaining an image by the light sensing devices;
calculating the total length of the shape boundary of each of the patterns shown in the obtained image; and
determining the corresponding light emitting device according to the total length of the shape boundary of each of the patterns shown in the obtained image.

7. The operation method as claimed in claim 6, wherein the step of calculating the total length of the shape boundary of each of the patterns shown in the obtained image comprising steps of:
labeling pixels in the image having sharp changes in brightness using an edge detection algorithm;
calculating total numbers of the labeled pixels belonging to each pattern; and
regarding the total numbers of the labeled pixels belonging to each pattern as the total length of the shape boundary of the corresponding patterns.

8. The operation method as claimed in claim 6, further comprising step of calculating position information of each of the patterns shown in the obtained image, wherein the position information of each of the patterns comprises at least one of a location data and a distance data, the location data indicates relative location of the fist light emitting device or the light emitting device on the display surface, the distance data indicates a distance between the first light emitting device and the display surface or a distance between the second light emitting device and the display surface.

9. The operation method as claimed in claim 6, further comprising step of determining a first angle between the light path of the light rays emitted from the first light emitting device and the display surface, a second angle between the light path of the light rays emitted from the second light emitting device and the display surface, a first rotation angle of the first light emitting device about a first axis thereof, or a second rotation angle of the second light emitting device about a second axis thereof, wherein the first axis is perpendicular to the first light emitting surface and through the center thereof, and the second axis is perpendicular to the second light emitting surface and through the center thereof.

10. The operation method as claimed in claim 6, wherein light emitted from the first light emitting device and the second light emitting device is infrared light, the display panel is configured with a plurality of infrared filters, the infrared light filters only permits infrared light passing through, and each of the light sensing device is coupled to one of the infrared light filters to obtain the image.
